(19) United States
(12) Patent Application Publication
(10) Pub. No.: US 2021/0286209 A1
(43) Pub. Date: Sep. 16, 2021

(54) DISPLAY DEVICE AND MOTHER BOARD

(71) Applicant: AU Optronics Corporation, Hsin-chu (TW)

(72) Inventors: Chih-Wen LU, HSIN-CHU (TW); Yun-Ru CHENG, HSIN-CHU (TW); Kuan-Yi LEE, HSIN-CHU (TW)

(21) Appl. No.: 17/065,827

(22) Filed: Oct. 8, 2020

(30) Foreign Application Priority Data
Mar. 13, 2020 (TW) 109108442

(51) Int. Cl. G02F 1/1339; G02F 1/1345

(52) U.S. Cl. CPC G02F 1/13394; G02F 1/133351; G02F 2001/13396; G02F 1/13458

(57) ABSTRACT

A display device includes a substrate, multiple spacers, multiple conductive particles, and a colloid layer. The spacers are disposed on the substrate. Each spacer has a first end closer to the substrate and a second end farther from the substrate, in which a width of the spacer is tapered from the first end to the second end. The conductive particles are disposed between the spacers. The colloid layer is disposed on the conductive particles and the spacers. A mother board is also disclosed.

### CROSS-REFERENCE TO RELATED APPLICATION

This application claims priority to Taiwan Application Serial Number 109108442, filed on Mar. 13, 2020, which is herein incorporated by reference in its entirety.

### BACKGROUND

### Technical Field

The present disclosure relates to a display device and a mother board.

### Description of Related Art

Among various electronic products, display devices using thin film transistors (TFT) have been widely used. The thin film transistor type display device is mainly composed of a thin film transistor array substrate, a color filter array substrate, and a display medium. The thin film transistor array substrate is provided with multiple thin film transistors arranged in an array and a pixel electrode corresponding to each thin film transistor to form a pixel structure.

During the manufacturing process of the display device, the substrate and the opposite substrate are adhered through the sealant firstly, and then the mother board is cut to separate the panels from each other. However, during the adhering process, the substances in the sealant may cause the problem of the non-uniform thickness of the panel, which affects the display quality of the manufactured display device, for example, it may cause non-uniform brightness.

### SUMMARY

One aspect of the present disclosure is to provide a display device including a substrate, multiple spacers, multiple conductive particles, and a colloid layer. The spacers are disposed on the substrate, in which each of the spacers has a first end closer to the substrate and a second end farther from the substrate, and the width of each of the spacers is tapered from the first end to the second end. The conductive particles are disposed between the spacers. The colloid layer is disposed on the conductive particles and the spacers.

Another aspect of the present disclosure is to provide a mother board including a first substrate, a second substrate, a colloid layer, multiple spacers, and multiple conductive particles. The first substrate has at least two in-plane areas. The second substrate is disposed opposite to the first substrate. The colloid layer disposed is around each of the in-plane areas. Each of the spacer has a first end closer to the first substrate and a second end farther from the first substrate, in which the width of each of the spacers is tapered from the first end to the second end. The conductive particles are disposed between the spacers.

The present disclosure is to dispose the spacers in the cutting area of the mother board, so that the thickness of the colloid layer in the cutting area can be reduced to facilitate the colloid layer to be split with the cutting process. Moreover, since the width of the spacer is tapered from the end close to the substrate to the end far away from the substrate, the conductive particles can be prevented from being stuck between the spacer and the substrate, thereby reducing the probability of the non-uniform brightness occurred at the edge of the in-plane area of the display device.

### BRIEF DESCRIPTION OF THE DRAWINGS

The present disclosure can be more fully understood by reading the following detailed description of the embodiment, with reference made to the accompanying drawings as follows:

FIG. 1 is a schematic top view of a mother board according to an embodiment of the present disclosure.

FIG. 2 is a schematic top view of a display device by cutting the mother board along the cutting line in FIG. 1.

FIG. 3 is a cross-sectional view taken along the line 3-3 in FIG.2.

FIG. 4 is a cross-sectional view taken along the line 4-4 in FIG. 2.

FIG. 5 is a partial enlarged view of the region R in FIG. 2.

FIG. 6, FIG. 9, and FIG. 12 are cross-sectional schematic views of the display device taken along the line A-A in FIG. 5 according to different embodiments of the present disclosure.

FIG. 7, FIG. 10, and FIG. 13 are cross-sectional schematic views of the display device taken along the line B-B in FIG. 5 according to different embodiments of the present disclosure.

FIG. 8, FIG. 11, and FIG. 14 are cross-sectional schematic views of the display device taken along the line C-C in FIG. 5 according to different embodiments of the present disclosure.

FIG. 15 and FIG. 16 are schematic top views of the mother board according to different embodiments of the present disclosure.

### DETAILED DESCRIPTION

The embodiments of the present disclosure are disclosed in the following drawings. For clarity, the practical details are described in the following description. However, it will be apparent to those skilled in the art that, in some embodiments of the present disclosure, these practical details are not necessary and therefore are not intended to limit the disclosure. In addition, some of the conventional structures and elements are shown in the drawings in a simplified schematic manner in order to simplify the drawings. In addition, the dimensions of the various elements in the drawings are not shown in actual scale for the convenience of the reader.

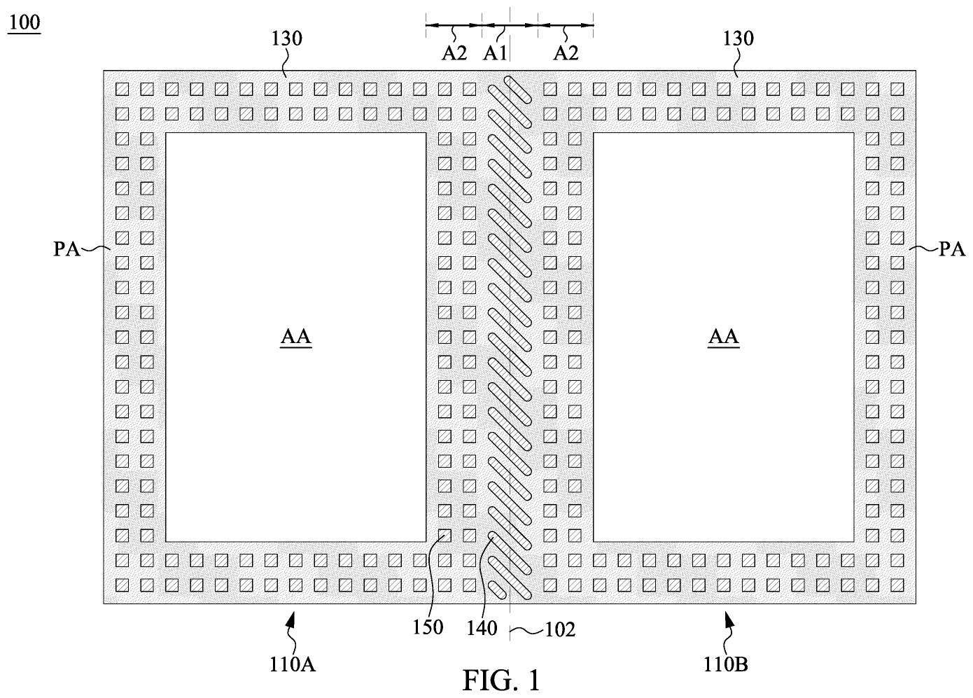

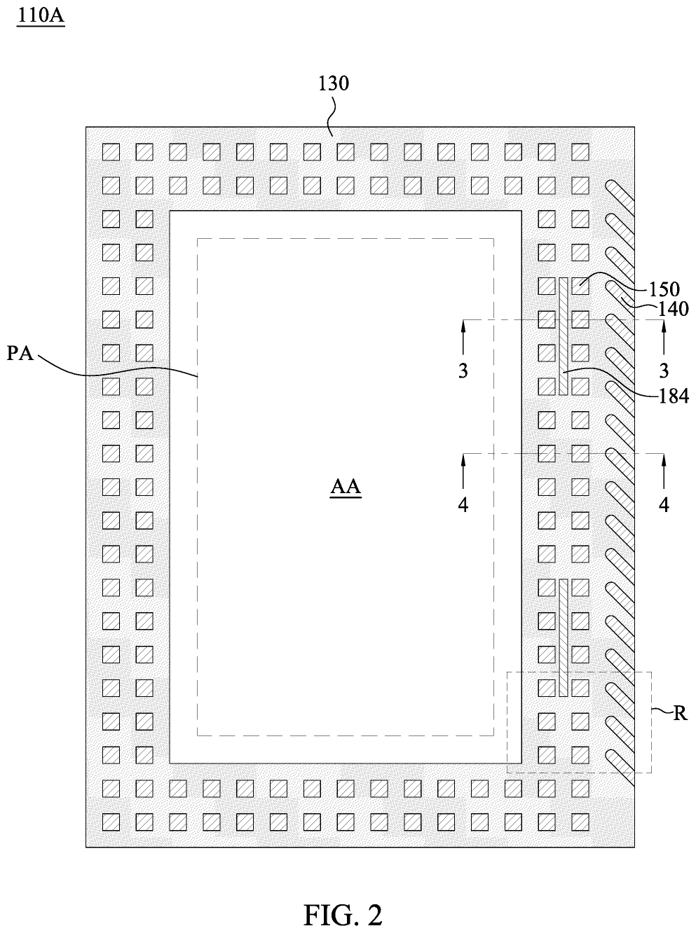

Reference is made to FIG. 1 in conjunction with FIG. 2. FIG. 1 is a schematic top view of a mother board 100 according to an embodiment of the present disclosure, and FIG. 2 is a schematic top view of a display device 110A by cutting the mother board 100 along the cutting line 102 in FIG. 1. For the sake of simplicity, conductive pads 184 in FIG. 2 are not shown in FIG. 1. The mother board 100 at least includes two connected display devices 110A and 110B. The mother board 100 may be manufactured by adhering the first substrate to the second substrate with a colloid layer 130. After adhering by the colloidal layer 130, the mother board 100 is presented as shown in FIG. 1, and then it can be cut along the cutting line 102 to separate the display devices 110A and 110B from each other.

In some embodiments, in order to split the colloid layer 130 with the cut first and second substrates, cutting spacers 140 are embedded in the colloid layer 130 for reducing the width of the colloid layer 130 in the positions along the cutting line 102. As the requirement for the bezel of the display device becomes narrower, the width of the colloid layer 130 is also limited. Therefore, in some embodiments, in other positions of the colloid layer 130, that is, not adjacent to the cutting line 102, supporting spacers 150 may be embedded in the colloid layer 130 for increasing the structural strength between the first substrate and the second substrate and maintaining the spacing between the first substrate and the second substrate.

In other words, the positions of the colloid layer 130 in the mother board 100 adjacent to the cutting line 102 can be defined as a cutting area A1, and other part of the colloid layer 130 can be regarded as a supporting area A2, in which the cutting area A1 includes the positions where the cutting line 102 is predetermined to pass and the supporting area A2 are located on opposite sides of the cutting area A1. The cutting spacers 140 are disposed in the cutting area A1, and the supporting spacers 150 are disposed in the supporting area A2. The arrangement pattern of the cutting spacer 140 may be different from the arrangement pattern of the supporting spacer 150. For example, the cutting spacer 140 may be a strip-shaped structure, and the supporting spacer 150 may be a pillar-shaped structure.

After the mother board 100 is cut along the cutting line 102, the display device 110A has an in-plane area AA and a peripheral area PA, and the peripheral area PA surrounds the in-plane area AA. In some embodiments, the number of the in-plane area AA of the mother board 100 is at least two. The in-plane area AA can be regarded as the display area of the display device 110A, and the peripheral area PA can be a wiring area of the display device 110A. The colloid layer 130 is also disposed in the peripheral area PA. In other words, the colloid layer 130 is arranged around the in-plane area AA and a part of the colloid layer 130 is located between the two in-plane areas AA. Furthermore, the colloidal layer 130 may completely cover the peripheral area PA or only partially cover the peripheral area PA. For example, the colloidal layer 130 does not completely cover the peripheral area PA but is only arranged around the outer edge of the peripheral area PA, that is, the outer edge of the peripheral area PA overlaps the colloid layer 130, but the peripheral area PA near the in-plane area AA may not necessarily cover the colloid layer 130. On the other hand, since the cutting line 102 is overlapped with the colloidal layer 130, the edge of the display device 110A overlaps the edge of the colloidal layer 130 after cutting. However, in the positions of the mother board 100 where the cutting line 102 does not pass, such as other side edges, the colloidal layer 130 can maintain a certain distance from the edge of the mother board 100 (or the display device 110A), rather than be aligned with it.

In the present embodiment, the cutting line 102 is taken as an example to cut through the long sides of the display device 110A and the display device 110B in FIG. 1 and FIG. 2. In practice, another cutting line further cuts through the short sides of the display device 110A and the display device 1108, and the description is not repeated herein.

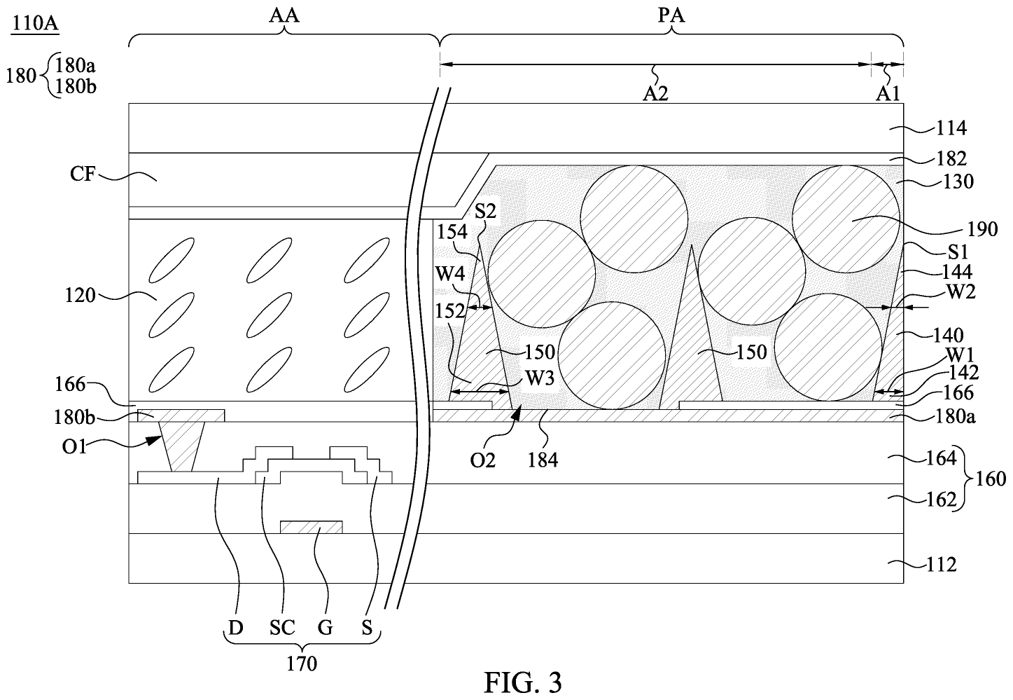

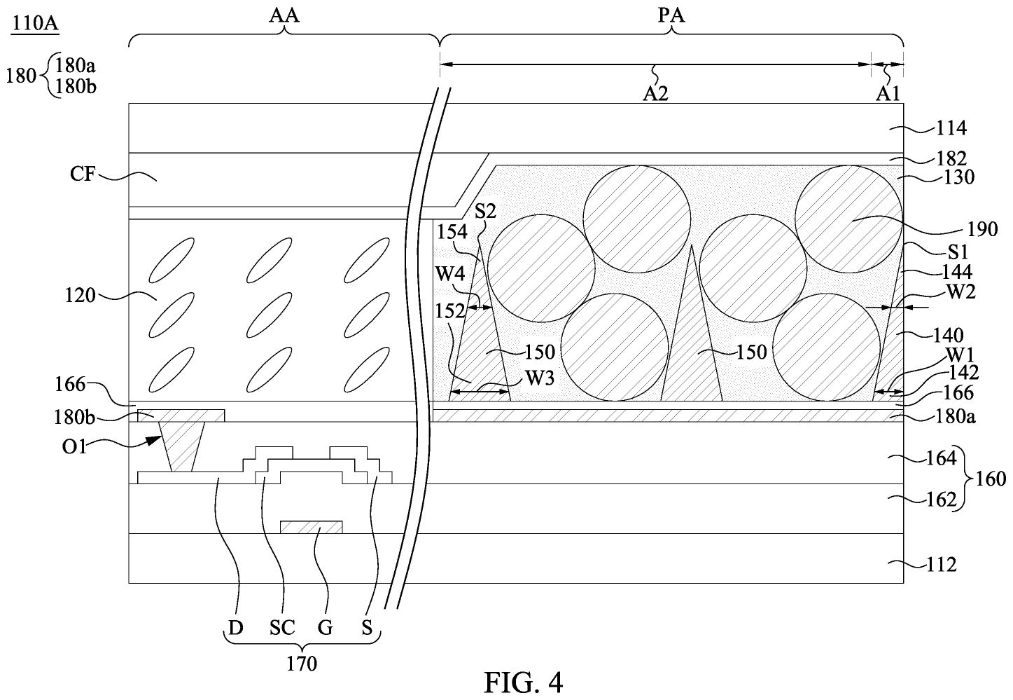

Reference is made to FIG. 3 and FIG. 4. FIG. 3 is a cross-sectional view taken along the line 3-3 in FIG.2, and FIG. 4 is a cross-sectional view taken along the line 4-4 in FIG. 2, in which the second substrate, the light shielding layer, and other parts of the in-plane area AA are omitted in FIG. 2 so that the top view therein is clearer and easier to understand. The display device 110A includes a first substrate 112, a second substrate 114, a liquid crystal layer 120, a colloid layer 130, cutting spacers 140, and supporting spacers 150. The first substrate 112 and the second substrate 114 are disposed relative to each other, and the liquid crystal layer 120, the colloid layer 130, the cutting spacers 140, and the supporting spacers 150 are disposed between the first substrate 112 and the second substrate 114. The present embodiment is provided on the first substrate 112 as an example for description.

The display device 110A has the in-plane area AA and the peripheral area PA, and the peripheral area PA surrounds the in-plane area AA. In some embodiments, the in-plane area AA can be regarded as the display area of the display device 110A, and the peripheral area PA may be the wiring area of the display device 110A. The colloid layer 130, the cutting spacers 140 and the supporting spacers 150 are also disposed in the peripheral area PA, in which the supporting spacers 150 are disposed between the cutting spacers 140 and the in-plane area AA. In some embodiments, the colloid layer 130 does not completely cover the peripheral area PA but is only disposed around the outer edge of the peripheral area PA, that is, the first substrate 112 and the second substrate 114 are not provided with the colloid layer 130 in the areas close to the inner side of the peripheral area PA.

The insulating layer 160 is disposed on the second substrate 114 and located in the in-plane area AA and the peripheral area PA. In some embodiments, the insulating layer 160 includes a gate insulating layer 162 and a passivation layer 164, and its material includes an inorganic material (e.g., silicon oxide, silicon nitride, silicon oxynitride, other suitable materials, or a combination thereof). The gate insulating layer 162 is disposed on the first substrate 112 and contacts the first substrate 112, and the passivation layer 164 is disposed on the gate insulating layer 162.

The switching element 170 is disposed in the in-plane area AA of the first substrate 112 and is covered by the passivation layer 164. The switching element 170 includes a gate G, a source S, a drain D, and a semiconductor layer SC. The gate G is disposed on the first substrate 112 and is covered by the gate insulating layer 162, and the source S, drain D, and semiconductor layer SC are disposed on the gate insulating layer 162 and is covered by the passivation layer 164.

The first conductive layer 180 is disposed on the insulating layer 160, wherein a first portion 180a of the first conductive layer 180 is located in the peripheral area PA as a peripheral wiring area, and a second portion 180b of the first conductive layer 180 (the figure only shows one) is disposed in the in-plane area AA to connect with the switch element 170. The passivation layer 164 of the insulating layer 160 may have a via hole O1, and the second portion 180b of the first conductive layer 180 may be electrically connected to the drain D of the switching element 170 through the via hole O1. The first conductive layer 180 can be further connected to related circuits such as a voltage source, a gate driving circuit, and a signal source.

The protection layer 166 is disposed on the first conductive layer 180 and the passivation layer 164. The first conductive layer 180 can be a single-layer or multi-layer structure, and its material includes a transparent conductive material (e.g., indium tin oxide, indium zinc oxide, zinc oxide, carbon nanotube, indium gallium zinc oxide, or other suitable materials), non-transparent conductive materials (e.g., metal, alloy, or other suitable materials), or other suitable materials.

A color filter layer CF and a second conductive layer 182 are disposed on the second substrate 114, in which the color filter layer CF includes a light shielding pattern and color resists disposed between the light shielding pattern, and the second conductive layer 182 is disposed on the color filter layer CF and the surface of the second substrate 114 facing the first substrate 112.

The liquid crystal layer 120 is disposed between the first substrate 112 and the second substrate 114, and is surrounded by the colloid layer 130. In some embodiments, the cutting spacers 140 and the supporting spacers 150 are disposed in the colloidal layer 130. The cutting spacers 140 are closer to the edges of the first substrate 112 and the second substrate 114 than the supporting spacers 150, and the supporting spacers 150 are closer to the liquid crystal layer 120 than the cutting spacers 140. In some embodiments, the material of the cutting spacers 140 and the supporting spacers 150 may be a photoresist material, which is directly manufactured on the first substrate 112 or the second substrate 114 through a photolithography process.

The colloid layer 130 is disposed between the first substrate 112 and the second substrate 114, and is located in the peripheral area PA. The colloid is configured to adhere the first substrate 112 to the second substrate 114, and to seal the liquid crystal layer 120. In the peripheral area PA, the colloid layer 130 covers the passivation layer 164 and the first conductive layer 180 thereon.

In some embodiments, the first conductive layer 180 disposed on the first substrate 112 may be required to be electrically connected to the second conductive layer 182 disposed on the second substrate 114. Therefore, the colloidal layer 130 is further provided with conductive particles 190 so that the first conductive layer 180 and the second conductive layer 182 are electrically conducted through the conductive particles 190.

As shown in FIG. 3, in the peripheral area PA, the protective layer 166 has an opening O2, so that part of the first conductive layer 180 is not covered by the protective layer 166 but is exposed through the opening O2 of the protective layer 166 to serve as a conductive pad 184. The conductive particles 190 connect the conductive pad 184 to the second conductive layer 182, so that the current provided by the voltage source is transmitted to the second conductive layer 182 through the conductive pad 184 and the conductive particles 190. In other words, through the conductive particles 190, when a voltage is applied to the conductive pad 184, the second conductive layer 182 also has a corresponding voltage, thereby coupling an electric field between the first conductive layer 180 and the second conductive layer 182. The coupled electric field can control the twist of the liquid crystal molecules in the liquid crystal layer 120.

In contrast, in other locations of the peripheral area PA, such as the location shown in FIG. 4, the protective layer 166 continuously covers the first conductive layer 180 to prevent the first conductive layer 180 from being eroded by water and oxygen and to prevent the first conductive layer 180 from being short-circuited with other components.

In order to well control the distribution positions of the conductive particles 190 to prevent the conductive particles 190 from being stuck between the cutting spacers 140 and the second substrate 114 or between the supporting spacers 150 and the second substrate 114, which causes a step difference between the in-plane area AA and the peripheral area AA that results in the light leakage, the cutting spacers 140 and the supporting spacers 150 in the present embodiment are designed to have a shape with a narrow top and a wide bottom, so that the conductive particles 190 can slide off along the outlines of the cutting spacers 140 and the supporting spacers 150 to fall in the spaces between the cutting spacers 140 and the supporting spacers 150 (or between the supporting spacers 150 and the supporting spacers 150). In this way, it can solve that the conductive particles 190 are stuck between the cutting spacers 140 and the second substrate 114 or between the supporting spacers 150 and the second substrate 114, which results in the possibility of non-uniform brightness occurred at the edges of the in-plane area AA in the display device 110A.

In some embodiments, in addition to having the outlines with a narrow top and a wide bottom, the cutting spacer 140 and the supporting spacer respectively have top surfaces S1 and S2, that is, the surfaces farther from the first substrate 112, which are non-planar convex surfaces. The top surface S1 of the cutting spacer 140 and the top surface S2 of the supporting spacer 150 may have shapes such as pointed end or convex surface, instead of plane or concave surface, so as to prevent the conductive particles 190 from staying on the top surface S1 of the cutting spacer 140 and the top surface S2 of the supporting spacer 150 rather than sliding off along the outlines of the cutting spacer 140 and the supporting spacer 150.

In other words, in addition to having the shapes with a narrow top and a wide bottom, the cutting spacer 140 and the supporting spacer 150 disposed on the first substrate 112 have the cross-sectional outlines which may be triangular, arc-shaped, bullet-shaped, etc. The cross-sectional outlines of the cutting spacer 140 and the supporting spacer 150 do not have a flat top surface or a concave top surface.

It should be noted that the cutting spacer 140 and the supporting spacer 150 described in the aforementioned paragraph have the shape with a narrow top and a wide bottom, which means that the cutting spacer 140 has a first end closer to the disposed substrate (e.g., the first substrate 112) and a second end 144 farther from the disposed substrate (e.g., the first substrate 112), and the width W1 of the first end 142 is greater than the width W2 of the second end 144. Furthermore, the width of the cutting spacer 140 is tapered from the first end 142 to the second end 144. Similarly, the supporting spacer 150 also has a first end 152 closer to the disposed substrate (e.g., the first substrate 112) and a second end 154 farther from the disposed substrate (e.g., the first substrate 112), in which the width W3 of the first end 152 is greater than the width W4 of the second end 154. Furthermore, the width of the supporting spacer 150 is tapered from the first end 152 to the second end 154. The second end 144 of the cutting spacer 140 and the second end 154 of the supporting spacer 150 are convex surfaces or pointed ends.

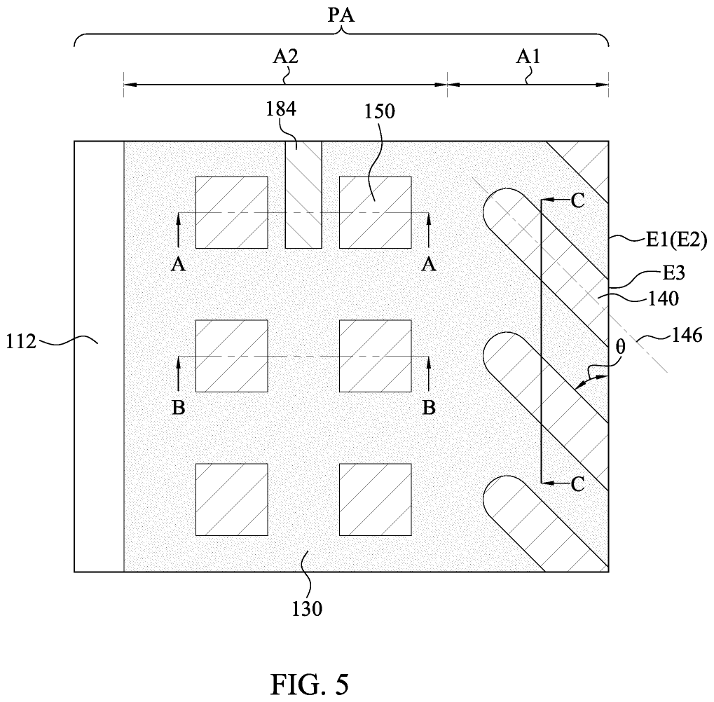

Reference is made to FIG. 5, which is a partial enlarged view of the region R in FIG. 2. The colloid layer 130 is disposed on the first substrate 112, and an edge E1 of the colloid layer 130 is aligned with an edge E2 of the first substrate 112. The colloid layer 130 includes a cutting area A1 and a supporting area A2. The cutting spacers 140 are disposed in the cutting area Al of the colloid layer 130, and the supporting spacers 150 are disposed in the supporting area A2 of the colloid layer 130. At least one conductive pad 184 is disposed in the supporting area A2 of the colloid layer 130. In some embodiments, the conductive pad 184 is distributed between the adjacent supporting spacers 150.

In some embodiments, the patterns of the cutting spacers 140 are different from the patterns of the supporting spacers 150. For example, the patterns of the cutting spacers 140 may be strip-shaped, and the patterns of the supporting spacers 150 may be pillar-shaped. One of the functions of the cutting spacers 140 is to reduce the thickness of the colloid layer 130 where the cutting line 102 (see FIG. 1) passes. Therefore, the cutting line 102 passes through the cutting spacers 140, and an edge E3 of the cutting spacers 140 are also aligned with the edge E2 of the first substrate 112 and the edge E1 of the colloid layer 130.

The long axis 146 of the cutting spacer 140 is not parallel to the edge E2 of the first substrate 112 but a non-zero angle θ is existed therebetween, in which the edge E2 of the first substrate 112 herein is equal to the extending direction of the cutting line 102. In some embodiments, the angle θ between the long axis 146 of the cutting spacer 140 and the edge E2 of the first substrate 112 is greater than zero degree and less than or equal to 90 degrees.

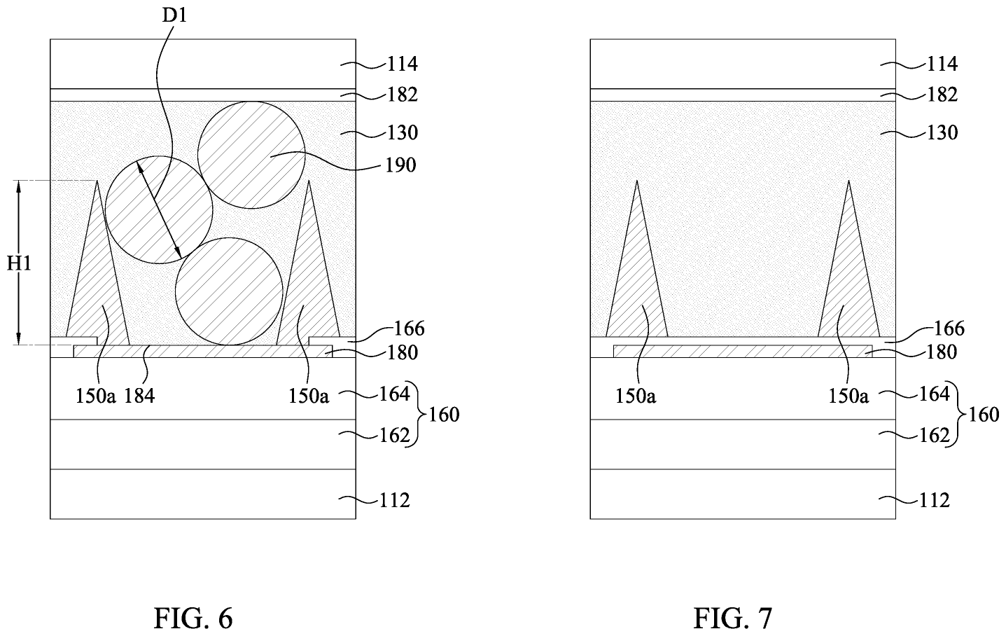

Next, references are made to FIG. 6 to FIG. 8, which are respectively cross-sectional schematic views taken along the lines A-A, B-B, and C-C in FIG. 5. The line A-A cuts through two supporting spacers 150a and the conductive pad 184, the line B-B cuts through two supporting spacers 150a without cutting through the conductive pad 184, and the line C-C cuts through two cutting spacers 140a.

In the embodiments shown in FIG. 6 to FIG. 8, the conductive particles 190 may only be distributed in the positions corresponding to the conductive pads 184, and the conductive particles 190 are not distributed in other positions of the colloidal layer 130. In the present embodiment, during manufacturing, the conductive particles 190 (or the colloid including the conductive particles 190) can be coated on the section covered by the conductive pad 184 firstly, and then the colloid layer 130 can be arranged to surround the first substrate 112. The conductive particles 190 can be distributed in the colloidal layer 130 during the process, so that the second conductive layer 182 on the second substrate 114 is electrically connected to the conductive pad 184 through the conductive particles 190.

In some embodiments, the cross-sectional shape of the cutting spacer 140a and the supporting spacer 150a is a triangle with a tip, and the diameter D1 of the conductive particle 190 is smaller than the height H1 of the cutting spacer 140a and the supporting spacer 150a. The conductive particles 190 are distributed between the supporting spacers 150a in a stacked manner. Two ends of the stacked conductive particles 190 respectively contact the conductive pad 184 and the second conductive layer 182, so that the stacked conductive particles 190 serve as a path of current loop. At this time, the conductive particles 190 may be disposed between the adjacent supporting spacers 150a, and at least one conductive particle 190 directly contacts the sidewall of the supporting spacers 150a. In the area where the conductive particles 190 are not provided, as shown in FIG. 7, the first conductive layer 180 is continuously covered by the protective layer 166. In some embodiments, the top surface of the support spacer 150a keeps a distance from the second substrate 114 without being in direct contact therewith.

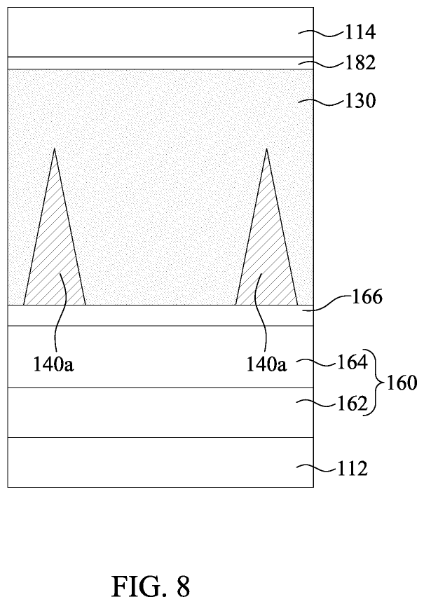

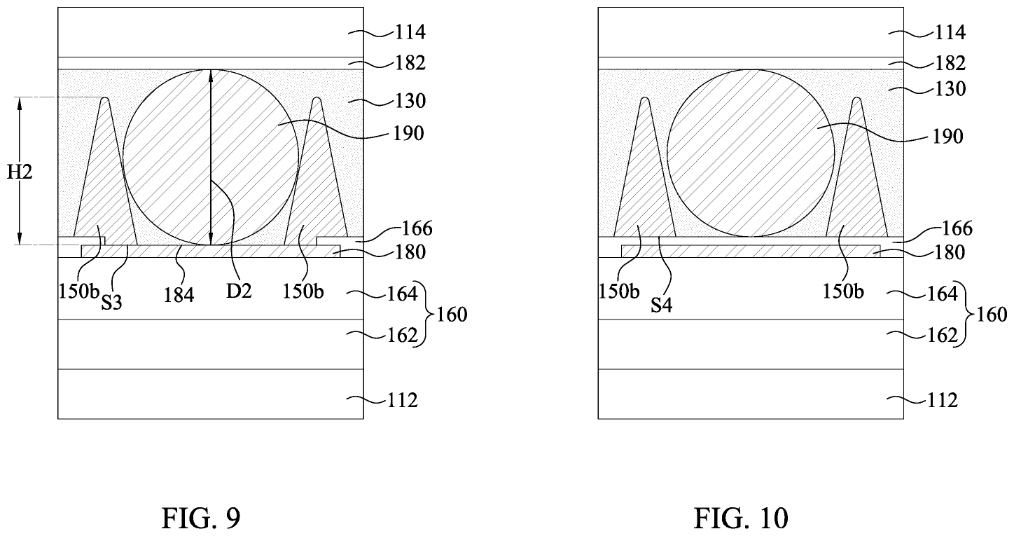

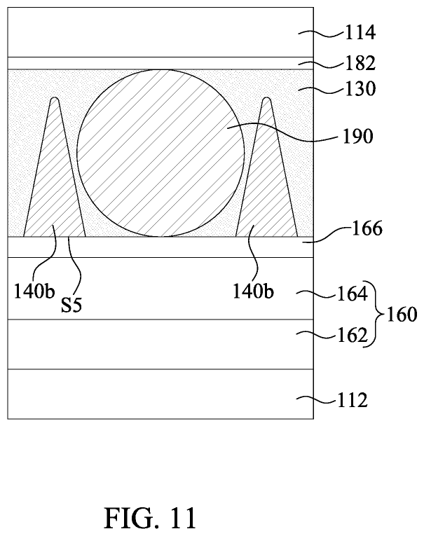

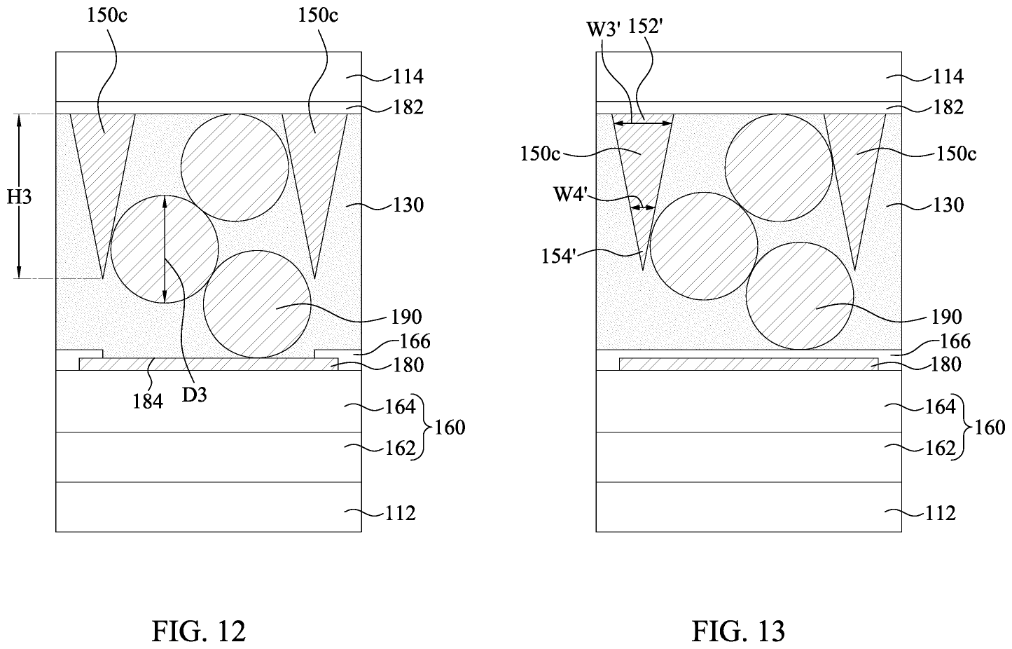

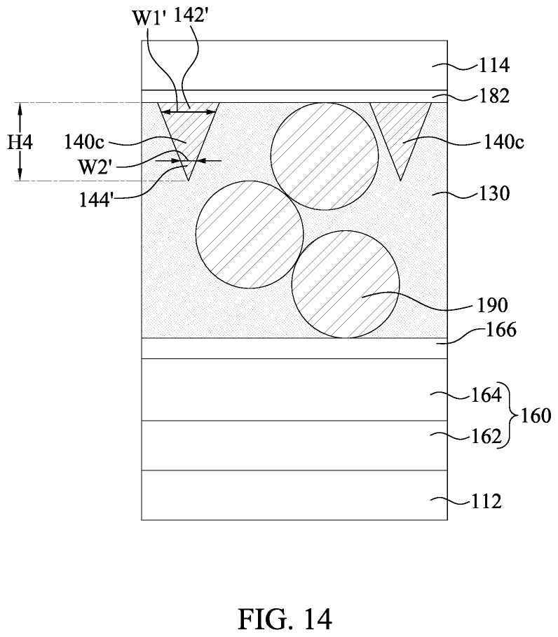

In some embodiments, the first conductive layer 180 does not enter the position of the cutting area as shown in FIG. 8 to prevent the first conductive layer 180 from being damaged by the cutting process to expose the first conductive layer 180 to affect the electrical property. The top surface of the cutting spacer 140a can keep a distance from the second substrate 114 without being in direct contact therewith. The cutting spacer 140a and the supporting spacer 150a can be manufactured by the same manufacturing process.

Next, references are made to FIG. 9 to FIG. 11, which are partial cross-sectional schematic views of the display device according to another embodiment of the present disclosure. The cross-sectional positions of FIG. 9, FIG. 10, and FIG. 11 are referred to the cross-sectional positions taken along the lines A-A, B-B, C-C in FIG. 5. In the embodiment shown in FIG. 9 to FIG. 11, the conductive particles 190 are uniformly distributed in the colloidal layer 130, and the diameter D2 of the conductive particle 190 is greater than the height H2 of the cutting spacer 140b and the supporting spacer 150b. As a result, the conductive particle 190 can be disposed between the first substrate 112 and the second substrate 114 without being stacked, and the first conductive layer 180 on the first substrate 112 and the second conductive layer 182 on the second substrate 114 are electrically conducted through the conductive particle 190.

The cross-sectional shapes of the cutting spacer 140b and the supporting spacer 150b may be approximately triangular, and the top surfaces of the cutting spacer 140b and the supporting spacer 150b are arc-shaped surfaces. In some embodiments, for part of the support spacers 150b, as shown in FIG. 9, the bottom surfaces S3 of the support spacers 150b contacts the conductive pad 184 and the protective layer 166 together. For another part of the support spacers 150b, as shown in FIG. 10, there is the protective layer 166 between the bottom surfaces S4 of the supporting spacers 150b and the first conductive layer 180 being used as isolation. The bottom surfaces S5 of the cutting spacers 140b are in contact with the protective layer 166, and the first conductive layer 180 may extend below the cutting spacer 140b or not.

Next, references are made to FIG. 12 to FIG. 14, which are partial cross-sectional schematic views of the display device according to another embodiment of the present disclosure. The cross-sectional positions of FIG. 12, FIG. 13, and FIG. 14 are referred to the cross-sectional positions taken along the lines A-A, B-B, C-C in FIG. 5. In the embodiments as shown in FIG. 12 to FIG. 14, the cutting spacers 140c and the supporting spacers 150c may also be disposed on the second substrate 114 rather than the first substrate 112. In this case, the cross-sectional shapes of the cutting spacers 140c and the supporting spacers 150c are wide at the top and narrow at the bottom. In other words, the cutting spacer 140c has a first end 142′ closer to the disposed substrate (e.g., the second substrate 114) and a second end 144′ farther from the disposed substrate (e.g., the second substrate 114), in which the width W1′ of the first end 142′ is greater than the width W2′ of the second end 144′. Furthermore, the width of the cutting spacer 140c is tapered from the first end 142′ to the second end 144′. Similarly, the supporting spacer 150c also has a first end 152′ closer to the disposed substrate (e.g., the second substrate 114) and a second end 154′ farther from the disposed substrate (e.g., the second substrate 114). The width W3′ of the first end 152′ is greater than the width W4′ of the second end 154′.

Furthermore, the width of the supporting spacer 150c is tapered from the first end 152′ to the second end 154′.

Similarly, the bottom surfaces of the cutting spacer 140c and the supporting spacer 150c facing the first substrate 112 are not planar surfaces or concave surfaces but arc-shaped convex surfaces or reduced tips, that is, the second end 144′ of the cutting spacer 140c and the second end 154′ of the supporting spacer 150c are convex surfaces or pointed ends used to prevent the conductive particles 190 from being stuck between the cutting spacers 140c and the first substrate 112 or between the supporting spacers 150c and the first substrate 112.

The diameter D3 of the conductive particle 190 may be greater or smaller than the height H3 of the supporting spacer 150c, so that the conductive particles 190 can electrically conduct the first conductive layer 180 on the first substrate 112 and the second conductive layer 182 on the second substrate 114 in a stack manner or a single conductive particle 190 is sufficient to electrically conduct the first conductive layer 180 on the first substrate 112 and the second conductive layer 182 on the second substrate 114. In some embodiments, the height H3 of the supporting spacer 150c may be greater than the height H4 of the cutting spacer 140c.

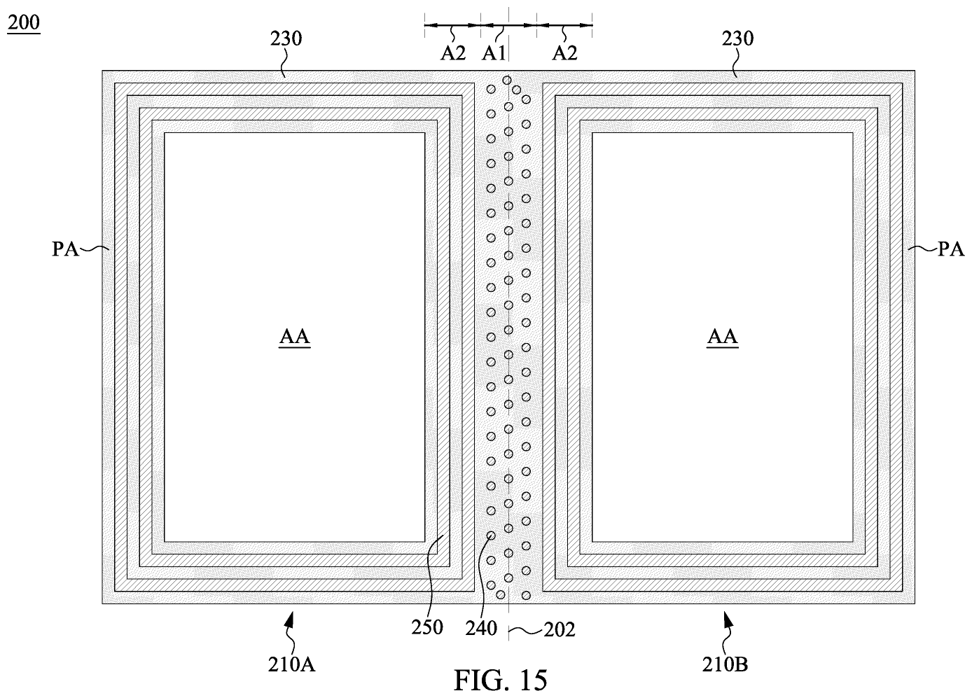

Reference is made to FIG. 15, which is a schematic top view of a mother board according to an embodiment of the present disclosure. The mother board 200 at least includes two connected display devices 210A and 210B. The mother board 200 can be manufactured by adhering the first substrate to the second substrate with the colloid layer 230, and then it can be cut along a cutting line 202 to separate the display devices 210A and 210B from each other.

In the present embodiment, the cutting spacers 240 disposed in the cutting area A1 may be segmented discontinuous structures. In other words, from the top view of the mother board 200, the cutting spacers 240 may be approximately point-shaped, and these point-shaped cutting spacers 240 are further arranged in a row along a predetermined direction, so that the rows of cutting spacers 240 and the cutting line 202 have an angle of non-90 degrees therebetween. As mentioned above, the cutting spacer 240 also has a cross-sectional shape with a narrow top and a wide bottom to prevent the conductive particles from being stuck between the cutting spacer 240 and the substrate, and it is not repeated herein.

The supporting spacers 250 disposed in the supporting area A2 are continuous structures, that is, from the top view of the mother board 200, the supporting spacers 250 may be approximately frame-shaped. In some embodiments, the supporting spacers 250 are double-layer continuous frame structures. As mentioned above, the supporting spacer 250 also has a cross-sectional shape with a narrow top and a wide bottom to prevent the conductive particles from being stuck between the support spacers 250 and the substrate, and it is not repeated herein.

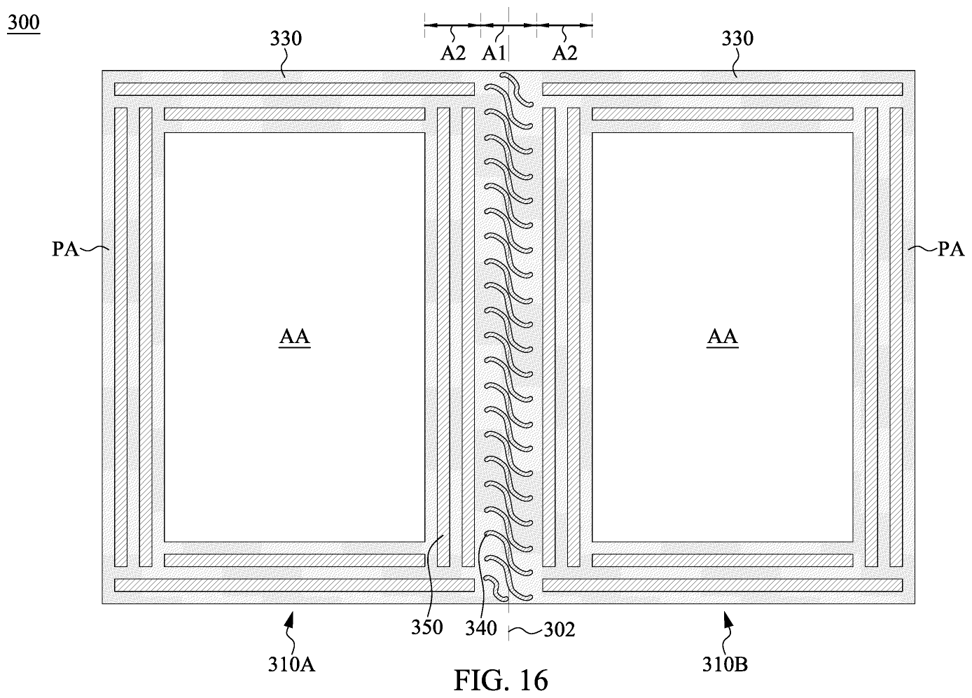

Next, reference is made to FIG. 16, which is a schematic top view of the mother board according to another embodiment of the present disclosure. The mother board 300 at least includes two connected display devices 310A and 310B. The mother board 300 can be manufactured by adhering the first substrate to the second substrate with a colloid layer 330, and then it can be cut along the cutting line 302 to separate the display devices 310A and 310B from each other.

In the present embodiment, the cutting spacers 340 disposed in the cutting area A1 may be continuous wave-shaped structures, and the extending direction of these wave-shaped cutting spacers 340 and the cutting line 302 have an angle of non-90 degrees therebetween. As mentioned above, the cutting spacer 340 also has a cross-sectional shape with a narrow top and a wide bottom to prevent the conductive particles from being stuck between the cutting spacers 340 and the substrate, and it is not repeated herein.

The supporting spacers 350 disposed in the support area A2 are strip-shaped and arranged in a frame shape. In some embodiments, the supporting spacer 350 has a double-layer structure. As mentioned above, the supporting spacer 350 also has a cross-sectional shape with a narrow top and a wide bottom to prevent the conductive particles from being stuck between the supporting spacers 350 and the substrate, and it is not repeated herein.

In summary, the present disclosure is to dispose the spacers in the cutting area of the mother board, so that the thickness of the colloid layer in the cutting area can be reduced to facilitate the colloid layer to be split with the cutting process. Moreover, since the width of the spacer is tapered from the end close to the substrate to the end far away from the substrate, the conductive particles can be prevented from being stuck between the spacer and the substrate, thereby reducing the probability of the non-uniform brightness occurred at the edge of the in-plane area of the display device.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A display device, comprising:
a substrate;
a plurality of spacers disposed on the substrate, wherein each of the spacers has a first end closer to the substrate and a second end farther from the substrate, and the width of each of the spacers is tapered from the first end to the second end;
a plurality of conductive particles disposed between the spacers; and
a colloid layer disposed on the conductive particles and the spacers.

2. The display device of claim 1, wherein the spacers are strip-shaped structures, and an edge of each of the spacers is aligned with an edge of the substrate.

3. The display device of claim 2, wherein an angle between a long axis of each of the spacers and the edge of the substrate is greater than zero degree and less than or equal to 90 degrees.

4. The display device of claim 1, wherein the second ends of the spacers are pointed ends or convex surfaces.

5. The display device of claim 1, wherein the diameters of the conductive particles are greater than the heights of the spacers.

6. The display device of claim 1, further comprising a conductive pad disposed on the substrate, wherein the conductive particles are only disposed in the positions corresponding to the conductive pad.

7. The display device of claim 1, wherein the conductive particles are distributed in the colloidal layer and disposed around the substrate.

8. A mother board, comprising:
a first substrate having at least two in-plane areas;
a second substrate disposed opposite to the first substrate;
a colloid layer disposed around each of the in-plane areas;
a plurality of spacers disposed on the first substrate and located in the colloidal layer, the spacers being located between the in-plane areas, wherein each of the spacer has a first end closer to the first substrate and a second end farther from the first substrate, wherein the width of each of the spacers is tapered from the first end to the second end; and
a plurality of conductive particles disposed between the spacers.

9. The mother board of claim 8, wherein the spacers comprises a plurality of cutting spacers and a plurality of supporting spacers, wherein the supporting spacers are disposed between the cutting spacers and the in-plane areas, the cutting spacers are strip-shaped structures, and the supporting spacers are pillar-shaped structures.

10. The mother board of claim 9, wherein the heights of the supporting spacers are greater than the heights of the cutting spacers.

11. The mother board of claim 9, wherein the diameters of the conductive particles are greater than the heights of the supporting spacers.

12. The mother board of claim 8, wherein the first substrate is an array substrate or a color filter substrate.
